(19) United States
(12) Patent Application Publication
(10) Pub. No.: US 2024/0332825 A1
(43) Pub. Date: Oct. 3, 2024

(54) CONTACT ASSEMBLY FOR CONNECTING AN ELECTRICAL CONDUCTOR AND CONDUCTOR CONNECTION TERMINAL WITH SUCH A CONTACT ASSEMBLY

(71) Applicant: WAGO Verwaltungsgesellschaft mbH, Minden (DE)

(72) Inventors: Sergej ZIER, Loehne (DE); Sebastian WEBER, Petershagen (DE); Sergej ISAAK, Stedesdorf (DE)

(73) Assignee: WAGO Verwaltungsgesellschaft mbH, Minden (DE)

(21) Appl. No.: 18/617,637

(22) Filed: Mar. 26, 2024

(30) Foreign Application Priority Data
Mar. 27, 2023 (DE) 20 2023 101 521.2

(51) Int. Cl. H01R 4/48

(52) U.S. Cl. CPC H01R 4/48185; H01R 4/4811

(57) ABSTRACT

A contact assembly for connecting an electrical conductor via a spring-loaded clamping. A conductor rail component is made of a conductor rail material and designed as a profile component angled parallel to the conductor insertion direction of an electrical conductor into the contact assembly, at least in sections. A spring component with a clamping spring is made of a spring material and is mechanically connected to the conductor rail component and is set up for clamping an electrical conductor via the clamping spring at a clamping point on the conductor rail component. A conductor insertion opening and a conductor insertion channel are connected to the conductor insertion opening, through which an electrical conductor inserted at the conductor insertion opening can be routed to the clamping point. The conductor insertion channel is formed from at least one first wall, a second wall, and a third wall.

This nonprovisional application claims priority under 35 U.S.C. § 119 (a) to German Patent Application No. 20 2023 101 521.2, which was filed in Germany on Mar. 27, 2023, and which is herein incorporated by reference.

### BACKGROUND OF THE INVENTION

### Field of the Invention

The invention relates to a contact assembly for connecting an electrical conductor via a spring-loaded clamping, comprising: a conductor rail component that is made of a conductor rail material, wherein the conductor rail component is designed as a profile component angled parallel to the conductor insertion direction of an electrical conductor into the contact assembly, at least in sections; a spring component with a clamping spring, wherein the spring component is made of a spring material, is mechanically connected to the conductor rail component and is set up for clamping an electrical conductor via the clamping spring at a clamping point on the conductor rail component; a conductor insertion opening and a conductor insertion channel connected to the conductor insertion opening, through which an electrical conductor inserted at the conductor insertion opening can be routed to the clamping point, wherein the conductor insertion channel is formed by at least a first wall, a second wall, and a third wall, wherein the first wall is substantially parallel to the second wall, and the third wall extends at least from the first wall to the second wall, and wherein the electrical conductor is insertable into the contact assembly in the space formed between the first wall, the second wall, and the third wall. The invention also relates to a conductor connection terminal having at least one such contact assembly.

### Description of the Background Art

A generic type of contact assembly is known from DE 20 2014 101 856 U1. The contact assembly, also known as a quick connect terminal, is used for direct soldering onto an electrical circuit board.

### SUMMARY OF THE INVENTION

It is therefore an object of the invention to further optimize a contact assembly, in particular for an application as a contact insert in a conductor connection terminal.

This object is achieved in an example with a contact assembly in that at least one wall of the conductor insertion channel, in particular the third wall, is formed partly from the conductor rail component and partly from the spring component. As a result, the contact assembly can be miniaturized in terms of size, wherein this design allows for the spring component to be mechanically connected to the conductor rail component in a particularly favorable way and the smoothest possible outer contour of the overall assembly to be realized. Such a smooth outer contour is in turn advantageous if the contact assembly is to be used as a contact insert of a conductor connection terminal and is accordingly to be used in a recess of a housing of the conductor connection terminal. In addition to the third wall, one or more further walls of the conductor insertion channel can also be formed partly from the conductor rail component and partly from the spring component.

As mentioned, the conductor rail component can be designed as an angled profile component, at least in sections. It can also be designed as an angled profile component throughout. The conductor rail component can be arranged in at least one section overlapping with the spring component, e.g., in the area of the third wall. The angled area of the conductor rail component extends at least in some areas in a section of the overlap of the conductor rail component and the spring component.

Advantageously, the conductor insertion channel can thus be formed partly from the conductor rail component and partly from the spring component starting from the conductor insertion opening. The conductor rail component can be made of a particularly conductive conductor rail material, such as copper or a copper alloy. The spring component can be made of a particularly good resilient material, in particular a material other than the conductor rail material. For example, a spring-hard steel material can be used.

The contact assembly can be made up of only these two components, i.e., the conductor rail component and the spring component.

The clamping point can be formed on the first wall. In this case, it is advantageous for the conductor rail component to form at least part of the first wall.

One wall of the first and second walls can be completely or at least partially formed from a section of the conductor rail component and the other wall of the first and second walls is formed completely or at least partly from a section of the spring component. Thus, the formation of the conductor insertion channel is divided between the two components, namely the conductor rail component and the spring component.

The third, which is partly formed from the conductor rail component and partly from the spring component, can have successive sections of the spring component and the conductor rail component in the conductor guide direction and/or orthogonal to the conductor insertion direction. If one or more further walls are formed partly from the conductor rail component and partly from the spring component, these can each have successive sections of spring component and conductor rail component in the conductor guide direction and/or orthogonal to the conductor insertion direction. In this way, the conductor rail component and the spring component can be nested together in a particularly cost-effective manner and can be connected to each other in a form-fit via nesting without additional complex fastening measures. In this case, the sections of the spring component and the conductor rail component, which follow one another in the conductor insertion direction and/or orthogonal to the conductor insertion direction, can be arranged aligned with each other, i.e., at the same height, so that essentially a smooth surface is obtained. If the material thickness of the conductor rail component and the spring component is essentially the same, it is particularly possible that an essentially step-free smooth surface is formed on both the outside and the inside of the conductor insertion channel.

The spring component can have a U-shaped curved section which forms at least part of the conductor insertion channel. In this way, a significant part of the conductor insertion channel can be formed from the spring component. In addition, such a U-shaped curved section can advantageously be coupled positively with an equally U-shaped curved section of the conductor rail component. Accordingly, in an example of the invention, the conductor rail component may also have a U-shaped curved section that forms at least part of the conductor insertion channel, whereby this ensures, for example, that an electrical conductor can be inserted in the conductor insertion channel without obstruction by snagging or the like.

The U-shaped curved section of the spring component can extend, for example, to the conductor insertion opening. The side legs of the U-shaped curved section can form parts of the third and a fourth wall; the connecting section between the side legs of the U-shaped section can form part of the second wall.

The conductor insertion channel can be U-shaped from the first wall, the second wall and the third wall or additionally has a fourth wall that closes the U-shape upwards and is opposite the third wall. In the first variant, the conductor insertion channel is thus open on one side where there is no fourth wall. This is particularly space-saving and advantageous when using the contact assembly as a contact insert in a conductor connection terminal housing, as a housing wall can then close off the conductor insertion channel to the open side.

The fourth wall can be formed partly from the conductor rail component and partly from the spring component. This has the advantage that the conductor rail component can be connected to the spring component even more easily and reliably via positive coupling. The fourth wall can have consecutive sections of the spring component and conductor rail component in the conductor insertion direction and/or orthogonal to the conductor insertion direction.

The second wall and the fourth wall, which are opposite each other, have consecutive sections of spring component and conductor rail component in the conductor insertion direction and/or orthogonal to the conductor insertion direction.

The spring component can be attached to the conductor rail component via form-fit and/or material-fit fastening. This allows for simple and reliable coupling of the spring component to the conductor rail component in terms of production technology. In the case of positive coupling, for example, a corresponding coupling contour may be disposed on the conductor rail component, e.g., in the form of a puzzle piece, and a coupling contour designed as a negative for this can be present on the spring component. In the case of material-fit fastening, this can be done, for example, by welding, soldering or clinching.

The spring component, formed as a clamping spring, can have a one-sided leaf spring, which can be designed as a spring tongue inclined towards the conductor insertion direction, which is arranged at an angle towards the conductor rail component and has a clamping edge at the free end, wherein the clamping point for clamping the electrical conductor is formed between the conductor rail component and the clamping edge. This allows for reliable and easy clamping of an electrical conductor with a comparatively simple design of the contact assembly. In particular, it is not necessary for symmetrical clamping to be achieved via two counter-rotating spring tongues. Due to the one-sided clamping by the inclined spring tongue, the electrical conductor can be reliably clamped to the clamping point on the conductor rail component and electrically contacted.

The spring tongue can be designed as a material tongue that is flared and bent away from the material of the spring component. This minimizes the number of components in the contact assembly and simplifies manufacturing and assembly.

The spring tongue can have a protruding actuating tab for actuating the spring tongue. This allows for simple and reliable mechanical actuating and, accordingly, a deflection of the spring tongue via an actuating element, such as an actuating lever, which will be explained below. For example, the actuating tab can be molded in one piece with the spring tongue. The actuating tab may protrude from the spring tongue in a direction leading away from the third wall.

The contact assembly can be designed as part of an electrical connector, wherein the contact assembly has at least one electrical contact molded to the conductor rail component on the side facing away from the conductor insertion opening. In this way, a miniaturized connector with advantageous spring pressure connection technology for the electrical conductors can be realized. In particular, it is possible to realize connectors with such contact assemblies with a pitch of only 2.5 mm.

The contact assembly can be designed as a contact insert of a conductor connection terminal. Accordingly, the contact assembly can be placed in the housing of such a conductor connection terminal. In particular, the contact assembly can be designed without solder terminal contacts, especially without SMD terminal contacts.

The above-mentioned object is also achieved by a conductor connection terminal with a housing and a contact assembly of the type described above arranged in the housing, or several contact assemblies of the type described above arranged next to each other in the housing in a stringing direction. Here, too, the advantages explained above can be realized. The housing can be designed as an insulating material housing.

The conductor connection terminal can be designed as an electrical connector, wherein the contact assembly or the contact assemblies each have at least one plug contact. In this way, a miniaturized connector with spring pressure connection technology can be provided with the contact assembly according to the invention.

The contact assembly or contact assemblies may each have an assigned, swiveling actuating lever, wherein one actuating lever is each set up to open the clamping point of an assigned contact assembly. This has the advantage that the user can easily open the clamping point by operating the actuating lever. There is no need for an additional actuating tool that is not part of the conductor connection terminal. As an alternative to an actuating lever, there may also be an actuating pusher or an actuating slider.

The spring tongue or its clamping edge of the clamping spring of the assigned contact assembly can be moved away from the conductor rail component by manual actuating of the respective swiveling actuating lever. By such manual actuating, the clamping point can be opened. When the clamping point is open, an electrical conductor can be placed at the clamping point or removed from the conductor connection terminal without significant effort.

The actuating lever can have a tangential lateral actuating surface arranged on its first or second long side for actuating the spring tongue. This has the advantage that the actuating lever can also be miniaturized well and thus enables the realization of a miniaturized conductor connection terminal with a plurality of contact assemblies. In addition, such tangential actuating of the clamping spring minimizes the required manual actuating force to operate the actuating lever.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIGS. 1, 2 show a contact assembly in an example in different perspective views,

FIG. 3 shows a contact assembly in an example,

FIG. 4 shows a contact assembly in an example,

FIG. 5 shows a contact assembly in an example,

FIG. 6 shows a contact assembly in an example,

FIG. 7 shows a contact assembly in an example,

FIG. 8 shows a contact assembly in an example,

FIG. 9 shows a plug-in connection formed with the contact assembly as shown in FIG. 8,

FIG. 10 shows the plug-in connection referred to in FIG. 9 with an actuating lever in the idle state,

FIG. 11 shows the plug-in connection as shown in FIG. 9 with the actuating lever in the actuated state, and

FIG. 12 shows a conductor connection terminal in the form of an electrical connector.

### DETAILED DESCRIPTION

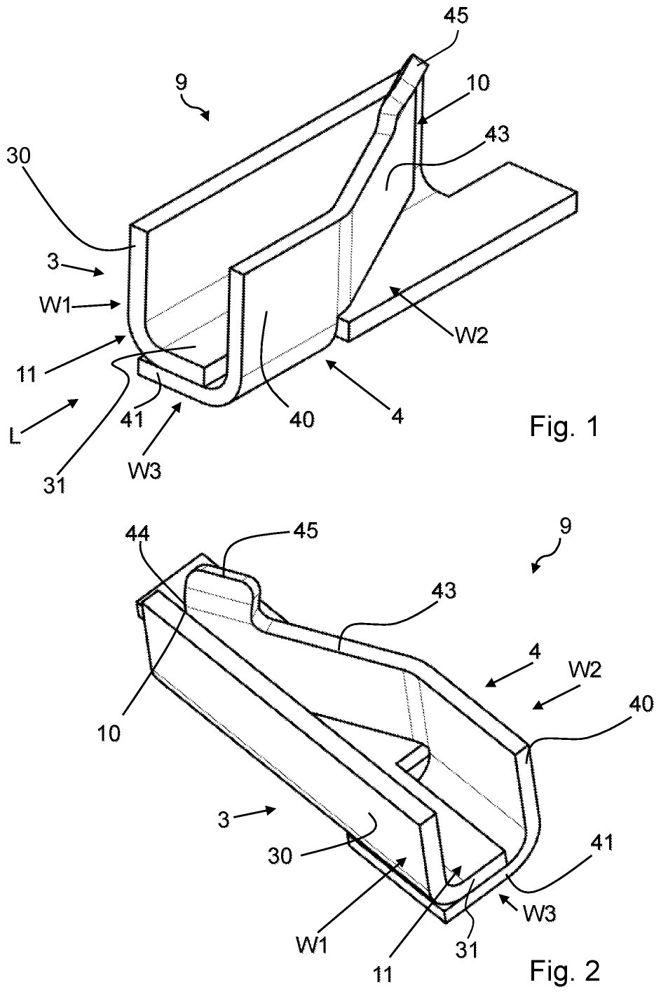

FIGS. 1 and 2 show a contact assembly 9 for connecting an electrical conductor via spring-loaded clamping. The contact assembly 9 has a conductor rail component 3, which is formed of a conductor rail material, and a spring component 4, which is made of a spring material. The spring component 4 has a clamping spring in the form of a one-sided leaf spring, which is formed as a spring tongue 43 and is made from the material of the spring component 4 and bent off. An electrical conductor can be inserted in the contact assembly 9 in a conductor insertion direction L through a conductor insertion opening 11 and can be routed to a clamping point 10, where the electrical conductor can be pressed against the conductor rail component 3 via the spring force of the spring tongue 43 and can thus be mechanically fixed and at the same time electrically contacted. The spring tongue 43 is inclined towards the conductor insertion direction L and points in the direction of the conductor rail component 3. The spring tongue 43 can have a clamping edge 44 at its free end.

On the spring tongue 43 there is also an actuating tab 45 protruding from the spring tongue 43, which can be used to actuate the spring tongue via an actuating element, e.g., an actuating lever described below. The actuating tab 45 may be slightly inclined with respect to the spring tongue 43.

As can be seen, the conductor rail component 3 can be designed as a profile component angled parallel to the conductor insertion direction L, at least in sections. In the example shown above, the conductor rail component in the drawing view has a vertical section 30 and a horizontal section 31, which is essentially arranged at right angles.

The spring component 4 can also be designed as a profile component angled parallel to the conductor insertion direction L, at least in sections. In the illustrated example, the spring component 4 has a vertical section 40 and a horizontal section 41, which is essentially arranged at right angles. The sections 31, 41 are arranged overlapping each other.

The contact assembly 9 has a conductor insertion channel connected to the conductor insertion opening 11, through which an electrical conductor inserted at the conductor insertion opening 11 is routed to the clamping point 10. The conductor insertion channel is formed from at least one first wall W1, a second wall W2 and a third wall W3. The first wall W1 is essentially parallel to the second wall W2. The third wall W3 extends at least from the first wall W1 to the second wall W2. In the illustrated example, the first wall W1 is formed from the section 30 of the conductor rail component, the second wall W2 is formed from the section 40 of the spring component 4. The third wall W3 is formed partly from the conductor rail component 3 and partly from the spring component 4, namely from the section 31 of the conductor rail component 3 and the section 41 of the spring component 4, which overlaps at least partially with the section 31. The section 41 extends in the conductor insertion direction L only over the length of the conductor insertion channel, i.e., up to the point where the inclined spring tongue 43 begins.

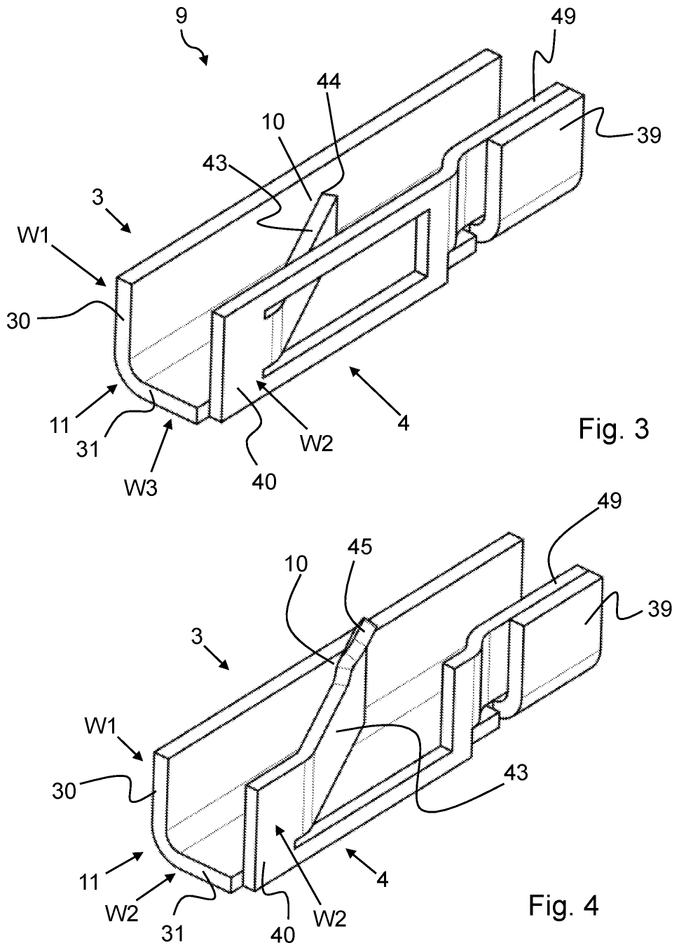

FIG. 3 shows an example of a contact assembly 9, which in turn, like the contact assembly already explained in FIGS. 1 and 2, has a conductor rail component 3 and a spring component 4. There is also a conductor insertion channel with the first wall W1, the second wall W2 and the third wall W3. In contrast to the example of FIGS. 1 and 2, in FIG. 3 the third wall W3 is formed exclusively from a section 31 of the conductor rail component 3. In this case, the spring tongue 43 has a window-like area made of the material of the spring component 4 and surrounded on all sides from the material of the spring component 4. Viewed in the conductor insertion direction L behind the clamping point 10, the spring component 4 has an end section 49, which is arranged overlapping with a leg 39 of a U-shaped area of the conductor rail component 3 on the end side. Via the end section 49, the spring component 4 can be fixed to the conductor rail component 3.

FIG. 4 shows an example of a contact assembly 9 which is designed in a similar way to the example of FIG. 3, wherein, in contrast to FIG. 3, the spring tongue 43 is similar to that in the example of FIGS. 1 and 2, i.e., it does not have a window-like opening of the spring component 4, but from a recess open on one side. The spring tongue 43 also has an actuating tab 45 located on the spring tongue 43, protruding from it.

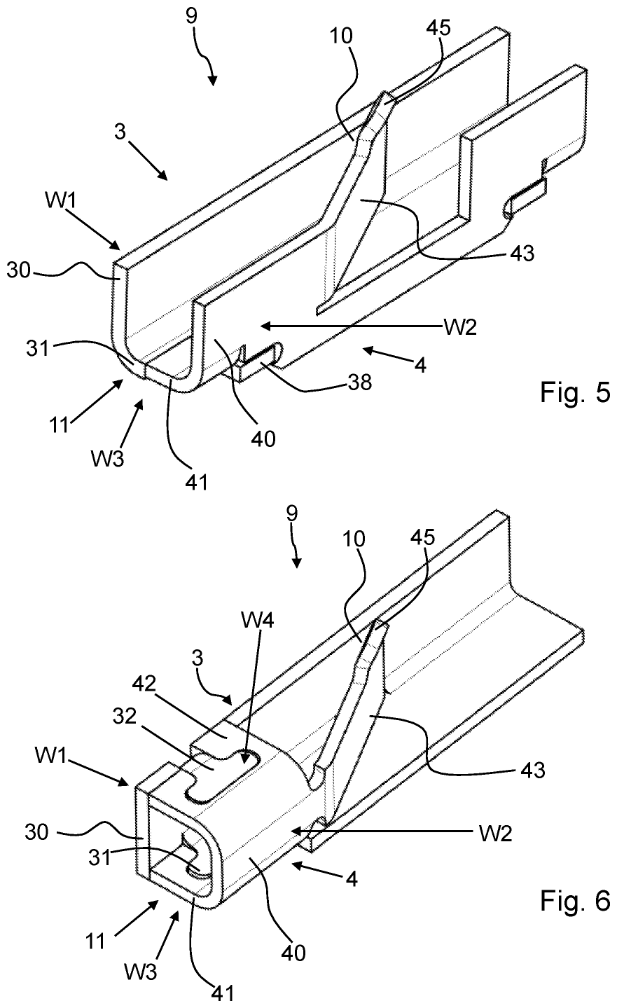

In the example of FIG. 5, the spring tongue 43 is similar to the example of FIG. 4. The conductor insertion channel is in turn formed from a first wall W1, a second wall W2 and a third wall W3. The first wall W1 is formed from a section 30 of the conductor rail component 3, the second wall W2 from a section 40 of the spring component 4. The third wall, W3, is formed from a section 31 of the conductor rail component and additionally from an adjoining section 41 of the spring component 4. The sections 31 and 41 may be arranged at least substantially at the same level, i.e., the section 31 essentially merges into the section 41 without steps. For example, if the material thicknesses of the spring material and the conductor rail material are somewhat uneven, a slight heel may be formed on the outside of the conductor insertion channel, and on the inside, the transition can be made essentially without a heel. The sections 31, 41 essentially form the third wall W3 in a direction orthogonal to the conductor insertion direction L, i.e., in a transverse direction, from successive sections of spring component 4 and conductor rail component 3.

It can also be seen in FIG. 5 that in the conductor insertion direction L, behind the section 41 and well before the clamping point 10, a further section 38 of the conductor rail component 3 is arranged, which also forms a part of the conductor insertion channel or the third wall W3. In this way, the third wall W3 in this area is formed from successive sections of spring component 4 and conductor rail component 3 in the conductor insertion direction L, namely from the section 41 and the following section 38.

On the other side, i.e., at the end facing away from the conductor insertion opening 11, the contact assembly 9 can be designed in a similar way as in the conductor insertion channel, wherein at the end facing away from the conductor insertion opening 11, the contact assembly 9 can be mirror-symmetrical to the conductor insertion channel.

FIG. 6 shows an example of a contact assembly 9 in which the conductor insertion channel is formed from four walls, namely a first wall W1, a second wall W2, a third wall W3 and a fourth wall W4. The first, second and third walls are arranged in a similar way to the examples described above, i.e., in a U-shape that is open at the top. In the example of FIG. 6, this U-shape is closed at the top, namely by the fourth wall W4, which is opposite the third wall W3 and is essentially parallel to it. This creates a conductor insertion channel that is closed on all sides around the circumference.

In the example of FIG. 6, the conductor rail component 3 forms the first wall W1 via section 30. Sections 31, 32 of the conductor rail component 3 protrude from section 30, which are essentially bent at right angles to it. The spring component 4 has a U-shaped curved section via which the second wall W2 and parts of the third wall W3 and the fourth wall W4 are formed. The side legs of the U-shape, i.e., sections 41, 42 of the spring component 4, have respective recesses to form a positive connection with the conductor rail component 3, which have an undercut in relation to the conductor rail component 3, e.g., a recess in the form of a puzzle piece. The conductor rail component 3 also has puzzle piece-shaped sections on its sections 31, 32, which form parts of the third wall W3 and the fourth wall W4, which are designed as a counterpart to the recesses in the sections 41, 42. Due to the puzzle-piece-shaped areas, a form-fitting coupling of the spring component 4 to the conductor rail component 3 is realized. In addition, both the third wall W3 and the fourth wall W4 are formed in the conductor insertion direction and additionally transversely to the conductor insertion direction from successive sections of spring component 4 and conductor rail component 3, namely in the area of the third wall W3 from sections 31, 41 and in the area of the fourth wall W4 from sections 32, 42.

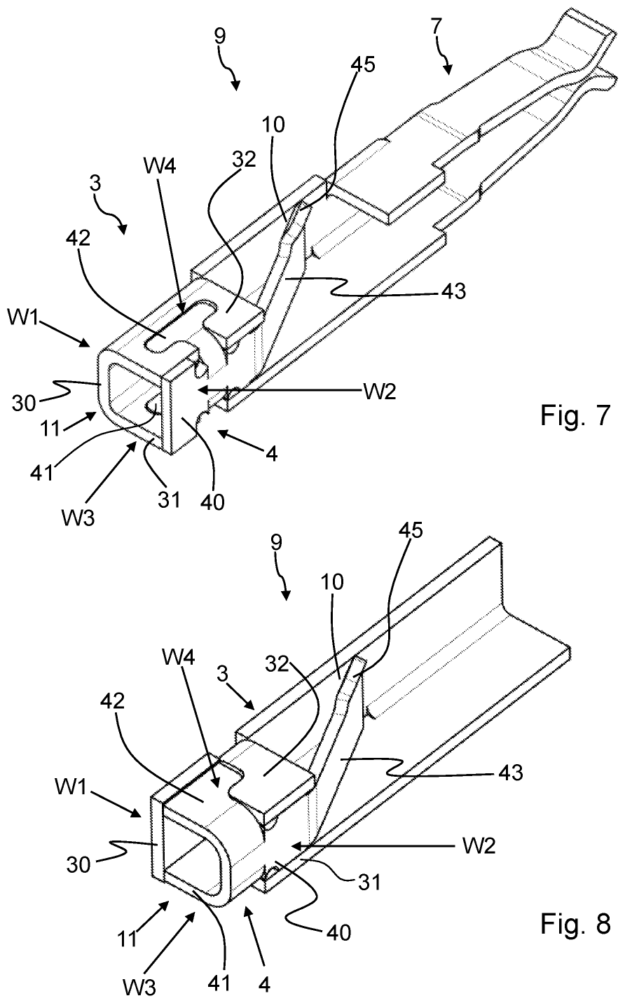

FIG. 7 shows an example of a contact assembly 9, which is formed with a comparable form-fitting coupling between the conductor rail component 3 and the spring component 4, i.e., again with puzzle-shaped sections in the area of the third wall W3 and the fourth wall W4. In contrast to the example of FIG. 6, in the example of FIG. 7, the conductor rail component 3 has a U-shaped curved area, which is formed from sections 30, 31, 32. In the example of FIG. 7, the puzzle-piece-shaped recesses are formed in sections 31, 32 of the conductor rail component 3. On the spring component 4, the contours engaging in the recesses of sections 31, 32 and formed as a counterpart are formed on sections 41, 42 bent away from the section 40. Due to the puzzle-piece-shaped areas, a form-fitting coupling of the spring component 4 to the conductor rail component 3 is realized. In addition, both the third wall W3 and the fourth wall W4 are formed in the conductor insertion direction and additionally transversely to the conductor insertion direction from successive sections of spring component 4 and conductor rail component 3, namely in the area of the third wall W3 from sections 31, 41 and in the area of the fourth wall W4 from sections 32, 42.

FIG. 7 also shows an example of the contact assembly 9 in which an electrical plug contact 7 is formed on the conductor rail component 3 in the conductor insertion direction L behind the clamping point 10, e.g., by one-piece molding from the material of the conductor rail component 3. The plug contact 7 can, for example, be designed as a fork contact or other socket contact, as shown, the plug contact 7 can also be designed differently, e.g., as a knife or pin contact. This allows for the contact assembly to be used as part of an electrical connector.

The example with the electrical plug contact 7 described above in FIG. 7 can also be combined with all other examples of the contact assembly 9, even if this is not explicitly shown in the drawings.

FIG. 8 shows an example of a contact assembly 9 in which the conductor rail component 3 is in turn coupled to the spring component 4 via a positive connection, wherein, similar to the examples of FIGS. 6 and 7, the conductor rail component 3 is nested with the spring component 4 in the area of the third and fourth walls W3, W4. In the example of FIG. 8, the spring component 4 has a U-shaped curved section in the area of the conductor insertion channel, which begins at the conductor insertion opening 11. In addition, the conductor rail component 3 also has a U-shaped area behind the U-shaped area of the spring component 4 in the conductor insertion direction L. The first wall W1 is formed from section 30 of the conductor rail component 3, the second wall W2 from section 40 of the spring component 4. The third wall W3 is formed in the conductor insertion direction and additionally transversely to the conductor insertion direction from successive sections 41, 31 of the spring component 4 and the conductor rail component 3, the fourth wall W4 is formed in the conductor insertion direction and additionally transversely to the conductor insertion direction from successive sections 42, 32 of the spring component 4 and the conductor rail component 3. Sections 31, 32 of the conductor rail component 3 each have a recess with an undercut, in which an area of the respective section 41, 42 of the spring component 4 projecting in the conductor insertion direction engages.

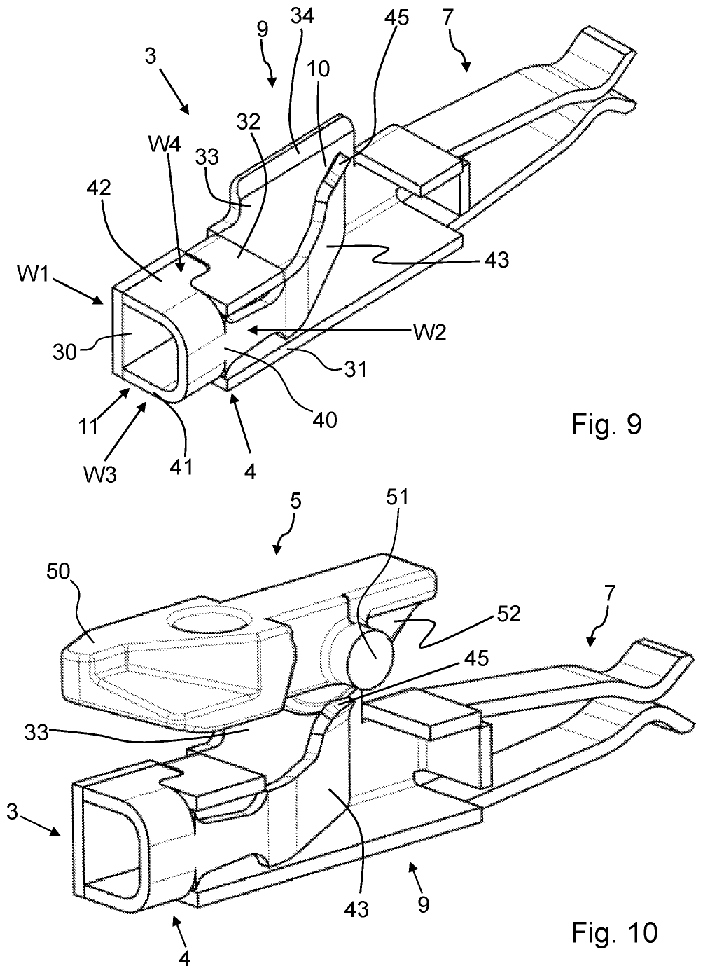

FIG. 9 shows a contact assembly 9, which is similar in design to that shown in FIG. 8 and also has a plug contact 7 molded to the conductor rail component 3. Furthermore, according to FIG. 9, the contact assembly has a support tab 33 on the conductor rail component, which extends to the plane of section 30 and is arranged at the marginal edge of section 30 facing away from the third wall W3. The support tab 33 is arranged in the conductor insertion direction L behind the conductor insertion channel and extends advantageously in the conductor insertion direction L beyond the clamping point 10. The support tab 33 is used to support the actuating lever, which is explained in more detail below. Advantageously, the support tab 33 can have a chamfer 34 facing the fourth wall W4 at the marginal edge facing away from the third wall W3.

FIG. 10 shows the contact assembly 9 as shown in FIG. 9 with a swiveling actuating lever 5 attached to it. The actuating lever 5 has a manual actuating section 50 where it can be operated manually. The actuating lever 5 is swiveled about an axis 51. The actuating lever 5 also has a tangential lateral actuating surface 52 located on one of its long sides for actuating the spring tongue 43. FIG. 10 shows the arrangement of the contact assembly 9 and the actuating lever 5 in the unactuated state of the actuating lever 5. When the actuating lever 5 is not actuated, the clamping point is closed, i.e., the spring tongue 43 rests against the conductor rail component 3 if no electrical conductor is inserted there or presses the electrical conductor against the conductor rail component 3. It can also be seen that the actuating lever 5 rests with a contact side opposite the tangential lateral actuating surface 52 against the support surface 33 of the conductor rail component 3.

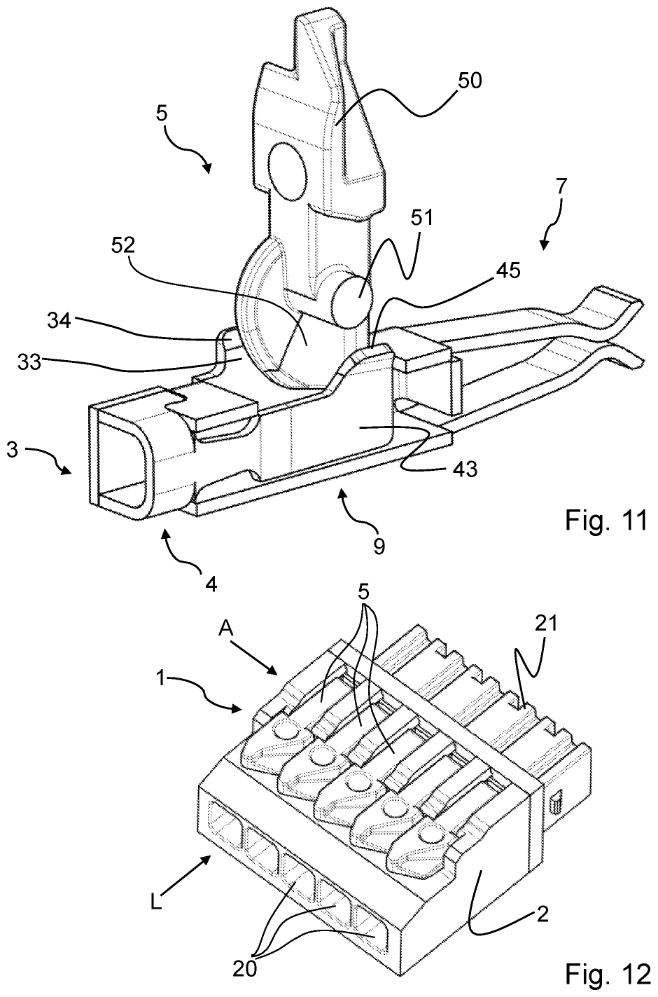

FIG. 11 shows the arrangement according to FIG. 10 with the actuating lever 5 in an actuated position. The actuating lever is now swiveled by a certain angle. Due to the actuating surface 52, which interacts with the actuating tab 45, the spring tongue 43 has now been deflected and thus moved away from its contact surface on the conductor rail component 3. In this state, the clamping point is open. Here, too, it can be seen that the actuating lever 5 rests with a contact side opposite the tangential lateral actuating surface 52 (which is not visible in the figure) on the support surface 33 of the conductor rail component 3. The force of the spring tongue 43 acting on the actuating lever 5 is thus absorbed by the support surface 33, so that a self-supporting contact assembly can be created in which no or only small forces are transferred to an insulating material housing surrounding the contact assembly.

FIG. 12 shows a conductor connection terminal 1 in the form of an electrical connector. The conductor connection terminal 1 has a housing 2 in which several contact assemblies 9 of the type described above are arranged next to each other in a stringing direction A. The housing 2 has a conductor insertion opening 20 for each contact assembly 9, through which an electrical conductor can be routed to the conductor insertion opening 11 and the conductor insertion channel of the contact assembly 9.

It can also be seen that for each contact assembly arranged in the housing 2, there is an actuating lever 5 for actuating the spring tongue 43. On the side diametrically opposed to the conductor insertion opening 20, the housing 2 has a mating area 21, with which the conductor connection terminal 1 or the electrical connector formed with it can be plugged together with a mating connector. Within the mating area 21 the respective plug contacts 7 of the contact assemblies 9 are arranged.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A contact assembly to connect an electrical conductor via spring-loaded clamping, the assembly comprising:
a conductor rail component made of a conductor rail material, the conductor rail component being designed as a profile component angled substantially parallel to an conductor insertion direction of an electrical conductor into the contact assembly, at least in sections;
a spring component with a clamping spring, the spring component being made of a spring material, and is mechanically connected to the conductor rail component and clamps an electrical conductor via the clamping spring at a clamping point on the conductor rail component;
a conductor insertion opening and a conductor insertion channel connected to the conductor insertion opening, through which an electrical conductor inserted at the conductor insertion opening is adapted to be routed to the clamping point, the conductor insertion channel being formed from at least one first wall, a second wall and a third wall, the first wall is essentially parallel to the second wall and the third wall extends at least from the first wall to the second wall,
wherein the electrical conductor in the space formed between the first wall, the second wall and the third wall is adapted to be inserted into the contact assembly, and
wherein at least the third wall of the conductor insertion channel is partly made up of the conductor rail component and partly of the spring component.

2. The contact assembly according to claim 1, wherein the clamping point is formed on the first wall.

3. The contact assembly according to claim 1, wherein one wall of the first and second walls is formed wholly or at least in part from a section of the conductor rail component and the other wall of the first and second walls is formed wholly or at least in part from a section of the spring component.

4. The contact assembly according to claim 1, wherein the third wall, which is partly formed from the conductor rail component and partly from the spring component, has consecutive sections of the spring component and conductor rail component in the conductor guide direction and/or orthogonal to the conductor insertion direction.

5. The contact assembly according to claim 1, wherein the spring component has a U-shaped curved section forming at least part of the conductor insertion channel.

6. The contact assembly according to claim 1, wherein the conductor insertion channel is surrounded in a U-shape from the first wall, the second wall and the third wall or additionally has a fourth wall closing the U-shape upwards and opposite the third wall.

7. The contact assembly according to claim 1, wherein the fourth wall is formed partly from the conductor rail component and partly from the spring component.

8. The contact assembly according to claim 1, wherein the spring component is attached to the conductor rail component via form-fit and/or material-fit fastening.

9. The contact assembly according to claim 1, wherein the spring component as a clamping spring has a one-sided leaf spring, which is designed as a spring tongue inclined to the conductor insertion direction, which is arranged at an angle in the direction of the conductor rail component and has a clamping edge at a free end, and wherein the clamping point is designed to clamp the electrical conductor between the conductor rail component and the clamping edge.

10. The contact assembly according to claim 9, wherein the spring tongue is designed as a material tongue that is flared and bent away from the material of the spring component.

11. The contact assembly according to claim 9, wherein the spring tongue has a protruding actuating tab for actuating the spring tongue.

12. The contact assembly according to claim 1, wherein the contact assembly is formed as part of an electrical connector, wherein the contact assembly has at least one electrical plug contact molded to the conductor rail component on a side facing away from the conductor insertion opening.

13. The contact assembly according to claim 1, wherein the contact assembly is designed as a contact insert of a conductor connection terminal.

14. A conductor connection terminal comprising:
a housing; and
a contact assembly according to claim 1, the contact assembly being arranged in the housing or several contact assemblies being arranged in a stringing direction in the housing next to each other.

15. The conductor connection terminal according to claim 14, wherein the conductor connection terminal is an electrical connector, and wherein the contact assembly or the contact assemblies each have at least one plug contact.

16. The conductor connection terminal according to claim 14, wherein the contact assembly or the contact assemblies each have an assigned swiveling actuating lever, and wherein an actuating lever is set up to open the clamping point of an assigned contact assembly.

17. The conductor connection terminal according to claim 16, wherein the spring tongue or its clamping edge of the clamping spring of the assigned contact assembly is adapted to be moved away from the conductor rail component by manually actuating the respective swiveling actuating lever.

18. The conductor connection terminal according to claim 17, wherein the actuating lever has a tangential lateral actuating surface arranged on its first or second long side for actuating the spring tongue.
